(19) United States
(12) Patent Application Publication
(10) Pub. No.: US 2017/0048747 A1
(43) Pub. Date: Feb. 16, 2017

(54) Device and Method of Handling Application Specific Congestion Control

(71) Applicant: HTC Corporation, Taoyuan City (TW)

(72) Inventor: Kundan Tiwari, Taoyuan City (TW)

(21) Appl. No.: 15/232,831

(22) Filed: Aug. 10, 2016

Related U.S. Application Data
(60) Provisional application No. 62/203,031, filed on Aug. 10, 2015.

(51) Int. Cl. H04W 28/02; H04W 48/18; H04W 76/02

(52) U.S. Cl. CPC H04W 28/0289; H04W 76/02; H04W 48/18

(57) ABSTRACT

A communication device for handling application specific congestion control comprises a storage unit for storing instructions and a processing circuit coupled to the storage unit. The processing circuit is configured to execute the instructions stored in the storage unit. The instructions comprise receiving information for barring an application category in a first cell of a first radio frequency of a registered public land mobile network (PLMN) from the registered PLMN; selecting a second cell of the registered PLMN, if a radio resource control (RRC) connection establishment procedure is not allowed for the application in the first cell of the first radio frequency; and performing the RRC connection establishment procedure to the second cell, if the RRC connection establishment procedure is allowed for the application in the second cell.

### CROSS REFERENCE TO RELATED APPLICATIONS

This application claims the benefit of U.S. Provisional Application No. 62/203,031, filed on Aug. 10, 2015, which is incorporated herein by reference.

### BACKGROUND OF THE INVENTION

1. Field of the Invention

The present invention relates to a device and a method used in a wireless communication system, and more particularly, to a device and a method of handling application specific congestion control.

2. Description of the Prior Art

A long-term evolution (LTE) system provides high data rate, low latency, packet optimization, and improved system capacity and coverage. In the LTE system, a radio access network known as an evolved universal terrestrial radio access network (E-UTRAN) includes at least one evolved Node-B (eNB) for communicating with at least one user equipment (UE), and for communicating with a core network including a mobility management entity (MME), a serving gateway, etc., for Non-Access Stratum (NAS) control.

A LTE-advanced (LTE-A) system is an evolution of the LTE system. The LTE-A system extends cell coverage of an eNB, increases peak data rate and throughput, and includes advanced techniques, such as carrier aggregation (CA), licensed-assisted access (LAA) using LTE, etc.

According to the prior art, a network (e.g., the core network or the eNB) can bar a UE from accessing a cell of the network, when a specific application is being used in the UE. The situation may happen, when the network intends to block the application during congestion of the network. However, the UE is not able to receive a service (e.g., emergency service) of the application, if the UE remains camping on the cell.

Thus, how to handle application specific congestion control is an important problem to be solved.

### SUMMARY OF THE INVENTION

The present invention therefore provides a communication device and method for handling application specific congestion control to solve the abovementioned problem.

A communication device for handling application specific congestion control comprises a storage unit for storing instructions and a processing circuit coupled to the storage unit. The processing circuit is configured to execute the instructions stored in the storage unit. The instructions comprise receiving information for barring an application category in a first cell of a first radio frequency of a registered public land mobile network (PLMN) from the registered PLMN; initiating a radio resource control (RRC) connection establishment procedure for the first cell of the first radio frequency for an application belonging to the application category; determining whether the RRC connection establishment procedure for the first cell of the first radio frequency is allowed by the registered PLMN for the application according to the information; selecting a second cell of the registered PLMN, if the RRC connection establishment procedure is not allowed for the application in the first cell of the first radio frequency; performing a location registration procedure to the second cell, if the location registration procedure is needed for the communication device; determining whether the RRC connection establishment procedure for the second cell is allowed by the registered PLMN for the application; and performing the RRC connection establishment procedure to the second cell, if the RRC connection establishment procedure is allowed for the application in the second cell.

A communication device for handling application specific congestion control comprises a storage unit for storing instructions and a processing circuit coupled to the storage unit. The processing circuit is configured to execute the instructions stored in the storage unit. The instructions comprise receiving information for barring an application category in a first cell of a first public land mobile network (PLMN) from the first PLMN; initiating a radio resource control (RRC) connection establishment procedure for the first cell of the first PLMN for an application belonging to the application category; determining whether the RRC connection establishment procedure for the first cell is allowed by the first PLMN for the application according to the information; selecting a second cell of a second PLMN, if the RRC connection establishment procedure is not allowed for the application in the first cell; performing a location registration procedure to the second cell of the second PLMN, if the location registration procedure is needed for the communication device; determining whether the RRC connection establishment procedure for the second cell is allowed by the second PLMN for the application; and performing the RRC connection establishment procedure to the second cell, if the RRC connection establishment procedure is allowed for the application in the second cell.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

### DETAILED DESCRIPTION

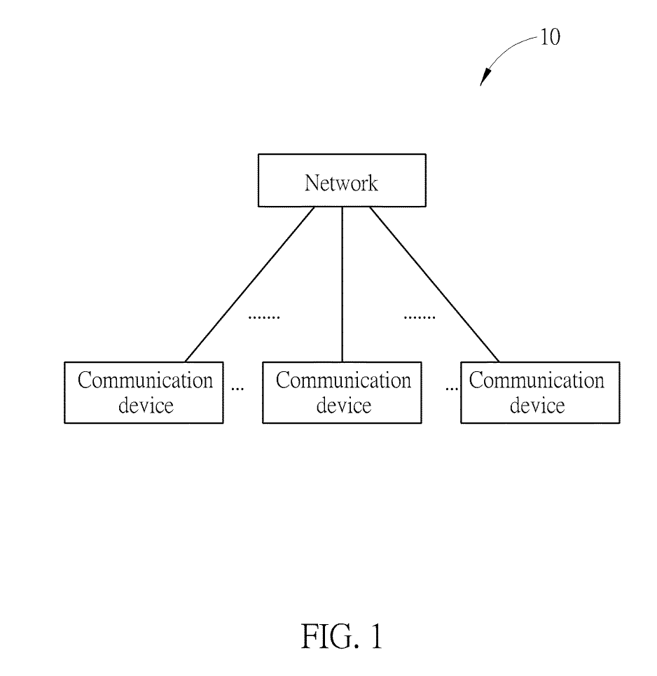

FIG. 1 is a schematic diagram of a wireless communication system 10 according to an example of the present invention. The wireless communication system 10 is briefly composed of a network and a plurality of communication devices. The network and a communication device may communicate with each other via one or more carriers of licensed band (s) and/or unlicensed band (s). The network and the communication device may simultaneously communicate with each other via multiple cells (e.g., multiple carriers) including a primary cell (PCell) and one or more secondary cells (SCells). The abovementioned cells may be operated in the same or different duplexing modes, i.e. frequency-division duplexing (FDD) and time-division duplexing (TDD). For example, the PCell may be operated on a licensed carrier, while the SCell may be operated on an unlicensed carrier.

In FIG. 1, the network and the communication devices are simply utilized for illustrating the structure of the wireless communication system 10. Practically, the network may be an evolved universal terrestrial radio access network (E-UTRAN) including at least one evolved Node-B (eNB) and/or at least one relay in a long term evolution (LTE) system, a LTE-Advanced (LTE-A) system or an evolution of the LTE-A system. The network may be a fifth generation (5G) network including at least one 5G base station (BS) which employs orthogonal frequency-division multiplexing (OFDM) and/or non-OFDM for communication with the communication devices. In general, a base station (BS) may also be used to refer any of the NB, the RNC, the eNB and the 5G BS.

A communication device may be a user equipment (UE), a machine type communication (MTC) device, a mobile phone, a laptop, a tablet computer, an electronic book, a portable computer system, a vehicle, an aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

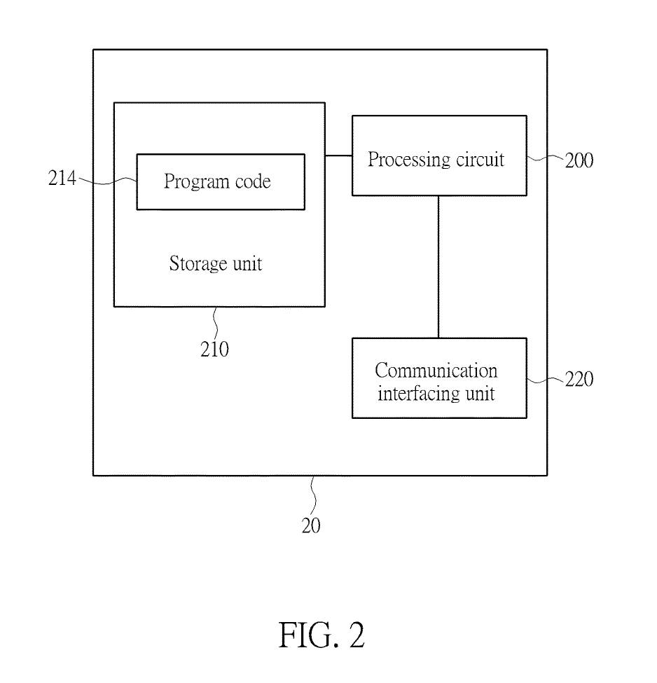

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage unit 210 and a communication interfacing unit 220. The storage unit 210 may be any data storage device that may store a program code 214, accessed and executed by the processing circuit 200. Examples of the storage unit 210 include but are not limited to a subscriber identity module (SIM), read-only memory (ROM), flash memory, random-access memory (RAM), hard disk, optical data storage device, non-volatile storage unit, non-transitory computer-readable medium (e.g., tangible media), etc. The communication interfacing unit 220 is preferably a transceiver and is used to transmit and receive signals (e.g., data, messages and/or packets) according to processing results of the processing circuit 200.

In the following embodiments, a UE is used to represent a communication device in FIG. 1, to simplify the illustration of the embodiments.

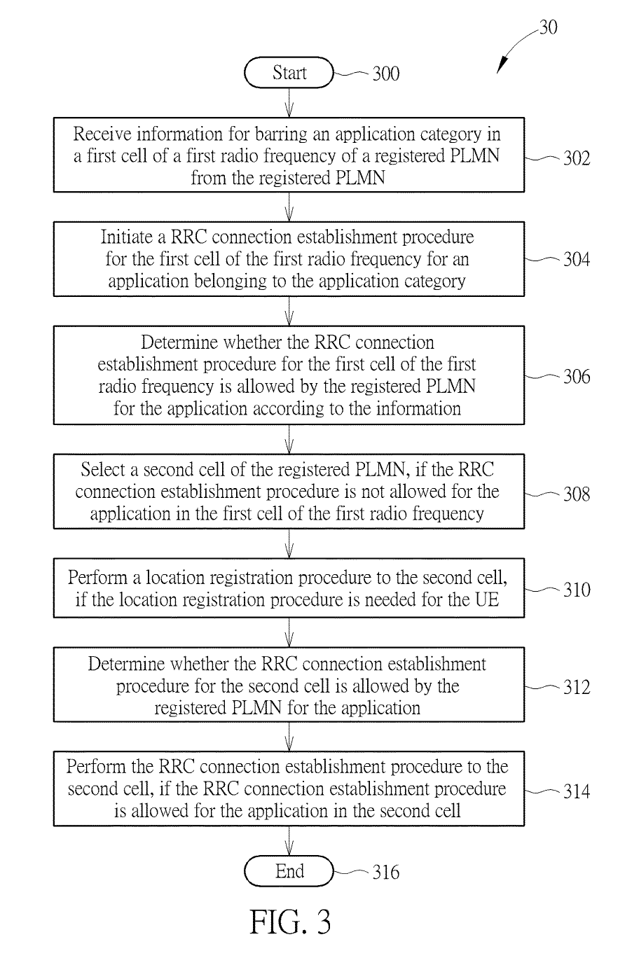

FIG. 3 is a flowchart of a process 30 according to an example of the present invention. The process 30 may be utilized in a UE, for handling application specific congestion control. The process 30 may be compiled into the program code 214 and includes the following steps:

Step 300: Start.

Step 302: Receive information for barring an application category in a first cell of a first radio frequency of a registered public land mobile network (PLMN) from the registered PLMN.

Step 304: Initiate a radio resource control (RRC) connection establishment procedure for the first cell of the first radio frequency for an application belonging to the application category.

Step 306: Determine whether the RRC connection establishment procedure for the first cell of the first radio frequency is allowed by the registered PLMN for the application according to the information.

Step 308: Select a second cell of the registered PLMN, if the RRC connection establishment procedure is not allowed for the application in the first cell of the first radio frequency.

Step 310: Perform a location registration procedure to the second cell, if the location registration procedure is needed for the UE.

Step 312: Determine whether the RRC connection establishment procedure for the second cell is allowed by the registered PLMN for the application.

Step 314: Perform the RRC connection establishment procedure to the second cell, if the RRC connection establishment procedure is allowed for the application in the second cell.

Step 316: End.

According to the process 30, the UE may receive information for barring an application category in a first cell of a first radio frequency of a registered PLMN (e.g., the network in FIG. 1) from the registered PLMN. Then, the UE may initiate a RRC connection establishment procedure for the first cell of the first radio frequency for an application (e.g., emergency service) belonging to the application category. To do so, the Non Access Stratum (NAS) of the UE initiates establishment of a RRC connection (e.g., the RRC connection establishment procedure) for the application. The UE may determine whether a radio resource control (RRC) connection establishment procedure for the first cell of the first radio frequency is allowed by the registered PLMN for the application according to the information. Then, the UE may select a second cell of the registered PLMN, if the RRC connection establishment procedure is not allowed for the application in the first cell of the first radio frequency. The UE may perform a location registration procedure to the second cell, if the location registration procedure is needed for the UE. The UE may determine whether the RRC connection establishment procedure for the second cell is allowed by the registered PLMN for the application. The UE may perform the RRC connection establishment procedure to the second cell, if the RRC connection establishment procedure is allowed for the application in the second cell. That is, a method for selecting a cell of a radio frequency is proposed in the process 30, to solve the problem that an application is barred for an original cell of an original radio frequency due to congestion control. Thus, the UE can receive a service of the application without being affected by the barring of the application.

Realization of the process 30 is not limited to the above description. The following examples may be applied to the process 30.

In one example, the UE may establishing a radio access bearer for a packet data protocol (PDP) context or an evolved packet system (EPS) context, and may transmit data of the application via the radio access bearer. In one example, the second cell may be operated on a second radio frequency of the registered PLMN. In this situation, the UE may start a timer. The UE may not select any cell on the first radio frequency of the registered PLMN, when the timer is running. Further, a value of the timer may be configured by the registered PLMN, or may be configured by the UE. That is, the timer is used for preventing the UE from accessing a congested radio frequency. An abovementioned RAT may be a Global System for Mobile Communications (GSM), a Universal Mobile Telecommunications System (UMTS), a High Speed Packet Access (HSPA) or a Code Division Multiple Access (CDMA) (e.g., CDMA2000). In one example, the UE may camp on the first cell of the first radio frequency.

In one example, the UE may receive the information from the registered PLMN by receiving system information comprising the information in an idle mode from the registered PLMN, when no RRC connection is established. In one example, the UE may determine whether the RRC connection establishment procedure for the second cell is allowed by the registered PLMN for the application according to the following steps. The UE may determine whether the application belongs to the application category according to control information configured in the UE or according to a subscriber identity module (SIM) of the UE. Then, the UE may determine whether the RRC connection establishment procedure for the second cell is allowed by the registered PLMN for the application according to whether the registered PLMN bars the application category.

In one example, the UE may select the second cell of the registered PLMN according to the following steps. The UE may determine whether there is the second cell with a second radio frequency in the registered PLMN. Then, the UE may search the second cell of the second radio frequency, when there is the second cell with the second radio frequency in the registered PLMN . Accordingly, the UE may select the second cell. That is, a condition of different radio frequencies and different RATs should be satisfied for selecting the second cell.

In one example, the UE may perform the location registration procedure to the second cell according to the following steps. The UE may transmit a tracking area update request message to the registered PLMN, may receive a tracking area update accept message in response to the tracking area update request message from the registered PLMN, and may transmit the tracking area update complete message to the registered PLMN. In one example, the UE may select the second cell of the registered PLMN by selecting the second cell, when the RRC connection establishment procedure is not allowed for all applications of the UE in the first cell of the first radio frequency.

An example illustrated as follows. When all applications of the UE in the first cell are barred, the UE may consider the first cell as barred. The applications may include at least two of Internet Protocol Multimedia Subsystem (IMS) voice call, IMS video call, IMS short message service (SMS), IMS emergency call, Rich Communications Service (RCS) and Internet applications. The Internet applications may include at least two of web browsing, email, WhatsAPP, Line, WeChat, Twitter and Skype.

In one example, the information may be broadcasted by the registered PLMN, if the UE is allowed to select the second cell and the application is barred in the first cell. In one example, the UE may determine whether the registered PLMN allows the UE to select the second cell, before the application is barred in the first cell. In one example, the application may include a circuit switched (CS) service or a packet switched (PS) service.

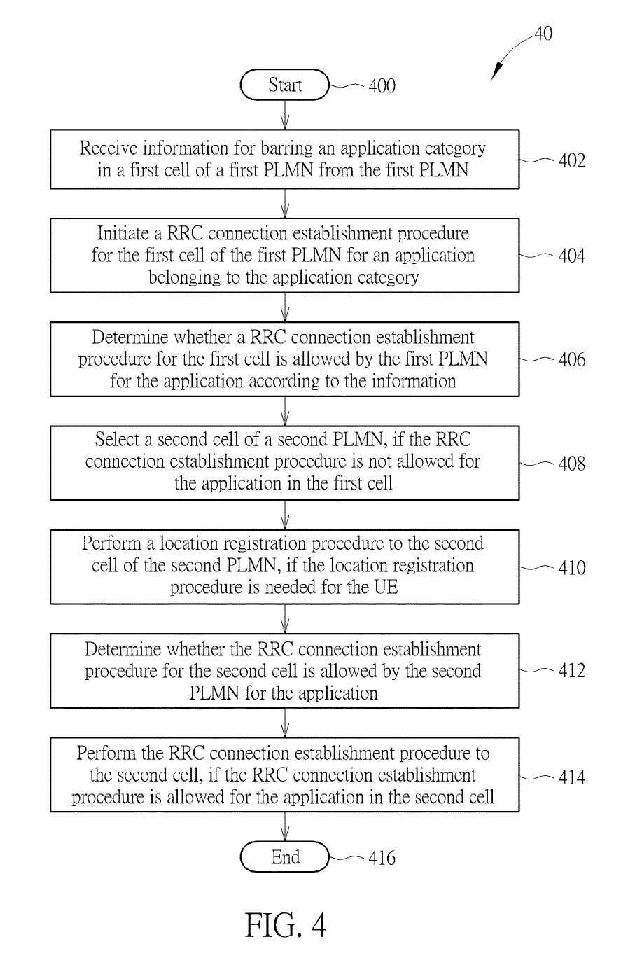

FIG. 4 is a flowchart of a process 40 according to an example of the present invention. The process 40 may be utilized in a UE, for handling application specific congestion control. The process 40 may be compiled into the program code 214 and includes the following steps:

Step 400: Start.

Step 402: Receive information for barring an application category in a first cell of a first PLMN from the first PLMN.

Step 404: Initiate a RRC connection establishment procedure for the first cell of the first PLMN for an application belonging to the application category.

Step 406: Determine whether a RRC connection establishment procedure for the first cell is allowed by the first PLMN for the application according to the information.

Step 408: Select a second cell of a second PLMN, if the RRC connection establishment procedure is not allowed for the application in the first cell.

Step 410: Perform a location registration procedure to the second cell of the second PLMN, if the location registration procedure is needed for the UE.

Step 412: Determine whether the RRC connection establishment procedure for the second cell is allowed by the second PLMN for the application.

Step 414: Perform the RRC connection establishment procedure to the second cell, if the RRC connection establishment procedure is allowed for the application in the second cell.

Step 416: End.

According to the process 40, the UE may receive information for barring an application category in a first cell of a first PLMN (e.g., the network in FIG. 1) from the first PLMN. Then, the UE may initiate a RRC connection establishment procedure for the first cell of the first PLMN for an application (e.g., emergency service) belonging to the application category. To do so, the Non Access Stratum (NAS) of the UE initiates establishment of a RRC connection (e.g., the RRC connection establishment procedure) for the application. The UE may determine whether a RRC connection establishment procedure for the first cell is allowed by the first PLMN for the application according to the information. Then, the UE may select a second cell of a second PLMN (e.g., another network not shown in FIG. 1), if the RRC connection establishment procedure is not allowed for the application in the first cell. The UE may perform a location registration procedure to the second cell of the second PLMN, if the location registration procedure is needed for the UE. The UE may determine whether the RRC connection establishment procedure for the second cell is allowed by the second PLMN for the application. The UE may perform the RRC connection establishment procedure to the second cell, if the RRC connection establishment procedure is allowed for the application in the second cell. That is, a method for selecting a PLMN is proposed in the process 40, to solve the problem that an application is barred for an original cell of an original PLMN due to congestion control. Thus, the UE can receive a service of the application without being affected by the barring of the application.

Realization of the process 40 is not limited to the above description. The following examples may be applied to the process 30.

In one example, the UE may establish a radio access bearer for a PDP context or an EPS context, and may transmit data of the application via the radio access bearer. In one example, the UE may start a timer, and may not select the first cell when the timer is running. Further, a value of the timer maybe configured by the first PLMN, or may be configured by the UE. That is, the timer is used for preventing the UE from accessing a congested cell. In one example, the UE may receive system information comprising the information in an idle mode from the first PLMN, when no RRC connection is established.

In one example, the UE may determine whether the RRC connection establishment procedure for the second cell is allowed by the second PLMN for the application according to the following steps. The UE determine whether the application belongs to the application category according to control information configured in the UE or according to a SIM of the UE. Then, the UE may determine whether the RRC connection establishment procedure for the second cell is allowed by the second PLMN for the application according to whether the second PLMN bars the application category.

In one example, the UE may perform the location registration procedure to the second cell according to the following steps. The UE may transmit a tracking area update request message to the second PLMN, may receive a tracking area update accept message in response to the tracking area update request message from the second PLMN, and may transmit the tracking area update complete message to the second PLMN. In one example, the UE may select the second PLMN by selecting the second PLMN, when the RRC connection establishment procedure is not allowed for all applications of the UE in the first cell. In one example, the application may include a CS service or a PS service.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device) , an electronic system, or combination thereof. An example of the means may be the communication device 20. Any of the processes above may be compiled into the program code 214.

To sum up, the present invention provides a communication device and method of handling application specific congestion control. The communication device selects a cell or a PLMN according to the present invention, to solve the problem that an application is barred for an original cell of an original PLMN due to congestion control. Thus, the communication device can receive a service of the application without being affected by the barring of the application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling application specific congestion control, comprising:
a storage unit, for storing instructions of:
receiving information for barring an application category in a first cell of a first radio frequency of a registered public land mobile network (PLMN) from the registered PLMN;
initiating a radio resource control (RRC) connection establishment procedure for the first cell of the first radio frequency for an application belonging to the application category;
determining whether the RRC connection establishment procedure for the first cell of the first radio frequency is allowed by the registered PLMN for the application according to the information;
selecting a second cell of the registered PLMN, if the RRC connection establishment procedure is not allowed for the application in the first cell of the first radio frequency;
performing a location registration procedure to the second cell, if the location registration procedure is needed for the communication device;
determining whether the RRC connection establishment procedure for the second cell is allowed by the registered PLMN for the application; and
performing the RRC connection establishment procedure to the second cell, if the RRC connection establishment procedure is allowed for the application in the second cell; and
a processing circuit, coupled to the storage unit, configured to execute the instructions stored in the storage unit.

2. The communication device of claim 1, wherein the storage unit further stores instructions of:
establishing a radio access bearer for a packet data protocol (PDP) context or an evolved packet system (EPS) context; and
transmitting data of the application via the radio access bearer.

3. The communication device of claim 1, wherein the second cell is operated on a second radio frequency of the registered PLMN, and the storage unit further stores instructions of:
starting a timer; and
no selecting any cell on the first radio frequency of the registered PLMN, when the timer is running.

4. The communication device of claim 3, wherein a value of the timer is configured by the registered PLMN, or is configured by the communication device.

5. The communication device of claim 1, wherein the instruction of receiving the information from the registered PLMN comprises:
receiving system information comprising the information in an idle mode from the registered PLMN, when no RRC connection is established.

6. The communication device of claim 1, wherein the instruction of determining whether the RRC connection establishment procedure for the second cell is allowed by the registered PLMN for the application comprises:
determining whether the application belongs to the application category according to control information configured in the communication device or according to a subscriber identity module (SIM) of the communication device; and
determining whether the RRC connection establishment procedure for the second cell is allowed by the registered PLMN for the application according to whether the registered PLMN bars the application category.

7. The communication device of claim 1, wherein the instruction of selecting the second cell of the registered PLMN comprises:
determining whether there is the second cell with a second radio frequency in the registered PLMN;
searching the second cell of the second radio frequency, when there is the second cell with the second radio frequency in the registered PLMN; and
selecting the second cell.

8. The communication device of claim 1, wherein the instruction of performing the location registration procedure to the second cell comprises:
transmitting a tracking area update request message to the registered PLMN;
receiving a tracking area update accept message in response to the tracking area update request message from the registered PLMN; and
transmitting the tracking area update complete message to the registered PLMN.

9. The communication device of claim 1, wherein the instruction of selecting the second cell of the registered PLMN comprises:
selecting the second cell, when the RRC connection establishment procedure is not allowed for all applications of the communication device in the first cell of the first radio frequency.

10. The communication device of claim 1, wherein the storage unit further stores an instruction of:
determining whether the registered PLMN allows the communication device to select the second cell, before the application is barred in the first cell.

11. The communication device of claim 1, wherein the application comprises a circuit switched (CS) service or a packet switched (PS) service.

12. A communication device for handling application specific congestion control, comprising:
a storage unit, for storing instructions of:
receiving information for barring an application category in a first cell of a first public land mobile network (PLMN) from the first PLMN;
initiating a radio resource control (RRC) connection establishment procedure for the first cell of the first PLMN for an application belonging to the application category;
determining whether the RRC connection establishment procedure for the first cell is allowed by the first PLMN for the application according to the information;
selecting a second cell of a second PLMN, if the RRC connection establishment procedure is not allowed for the application in the first cell;
performing a location registration procedure to the second cell of the second PLMN, if the location registration procedure is needed for the communication device;
determining whether the RRC connection establishment procedure for the second cell is allowed by the second PLMN for the application; and
performing the RRC connection establishment procedure to the second cell, if the RRC connection establishment procedure is allowed for the application in the second cell; and
a processing circuit, coupled to the storage unit, configured to execute the instructions stored in the storage unit.

13. The communication device of claim 12, wherein the storage unit further stores instructions of:
establishing a radio access bearer for a packet data protocol (PDP) context or an evolved packet system (EPS) context; and
transmitting data of the application via the radio access bearer.

14. The communication device of claim 12, wherein the storage unit further stores instructions of:
starting a timer; and
no selecting the first cell, when the timer is running.

15. The communication device of claim 14, wherein a value of the timer is configured by the first PLMN, or is configured by the communication device.

16. The communication device of claim 12, wherein the instruction of receiving the information from the first PLMN comprises:
receiving system information comprising the information in an idle mode from the first PLMN, when no RRC connection is established.

17. The communication device of claim 12, wherein the instruction of determining whether the RRC connection establishment procedure for the second cell is allowed by the second PLMN for the application comprises:
determining whether the application belongs to the application category according to control information configured in the communication device or according to a subscriber identity module (SIM) of the communication device; and
determining whether the RRC connection establishment procedure for the second cell is allowed by the second PLMN for the application according to whether the second PLMN bars the application category.

18. The communication device of claim 12, wherein the instruction of performing the location registration procedure to the second cell comprises:
transmitting a tracking area update request message to the second PLMN;
receiving a tracking area update accept message in response to the tracking area update request message from the second PLMN; and
transmitting the tracking area update complete message to the second PLMN.

19. The communication device of claim 12, wherein the instruction of selecting the second PLMN comprises:
selecting the second PLMN, when the RRC connection establishment procedure is not allowed for all applications of the communication device in the first cell.
